(19) United States
(12) Patent Application Publication
(10) Pub. No.: US 2015/0014345 A1
(43) Pub. Date: Jan. 15, 2015

(54) AUTOMATIC VENDING MACHINE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: Chin-Wen YEH, New Taipei (TW); Yang XIAO, Wuhan (CN); Chao FENG, Wuhan (CN)

(73) Assignees: HONG FU JIN PRECISION INDUSTRY (WuHan) CO., LTD., Wuhan (CN); HON HAI PRECISION INDUSTRY CO., LTD., New Taipei (TW)

(21) Appl. No.: 14/256,197

(22) Filed: Apr. 18, 2014

(30) Foreign Application Priority Data
Jul. 5, 2013 (CN) 2013102813079

(51) Int. Cl. G07F 9/10

(52) U.S. Cl. CPC G07F 9/105
USPC 221/150 HC

(57) ABSTRACT

An automatic vending machine includes a hot warehouse, a cold warehouse, a refrigeration system for cooling the cold warehouse, a heat system, and a refrigeration system. The heat system includes a ventilation device, a first heat dissipating device, a second heat dissipating device, and a valve. The control system includes a control module for controlling the heat system. The valve is rotatable by the control module to allow the ventilation device to communicate with the refrigeration system and the hot warehouse. The first heat dissipating device and the second heat dissipating device are controllable by the control module, for allowing hot air generated by the refrigeration system to flow through the ventilation device into the hot warehouse.

### FIELD

The present disclosure relates to automatic vending machines, and particularly to an automatic vending machine with a heat system and a refrigeration system.

### BACKGROUND

Automatic vending machines allow customers to buy merchandise twenty-four hours a day. Various merchandise, such as cold drinks and hot drinks, is stored in the automatic vending machines to be satisfied with daily wants. Therefore, a cooling system and a heating system are located in the automatic vending machines for cooling or heating drink. The automatic vending machines often comprise a cooling system such that an additional heating system needs to be added in the automatic vending machines.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an automatic vending machine.

FIG. 2 is an exploded, isometric view of a heat system of the automatic vending machine.

FIG. 3 is a block diagram of one embodiment of function modules of a control system and the heat system of the automatic vending machine of FIG. 1.

FIG. 4 is an assembled view of the heat system of FIG. 2, with a pair of shielding pieces in a first position.

FIG. 5 is similar to FIG. 4, but the pair of shielding pieces is in a second position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

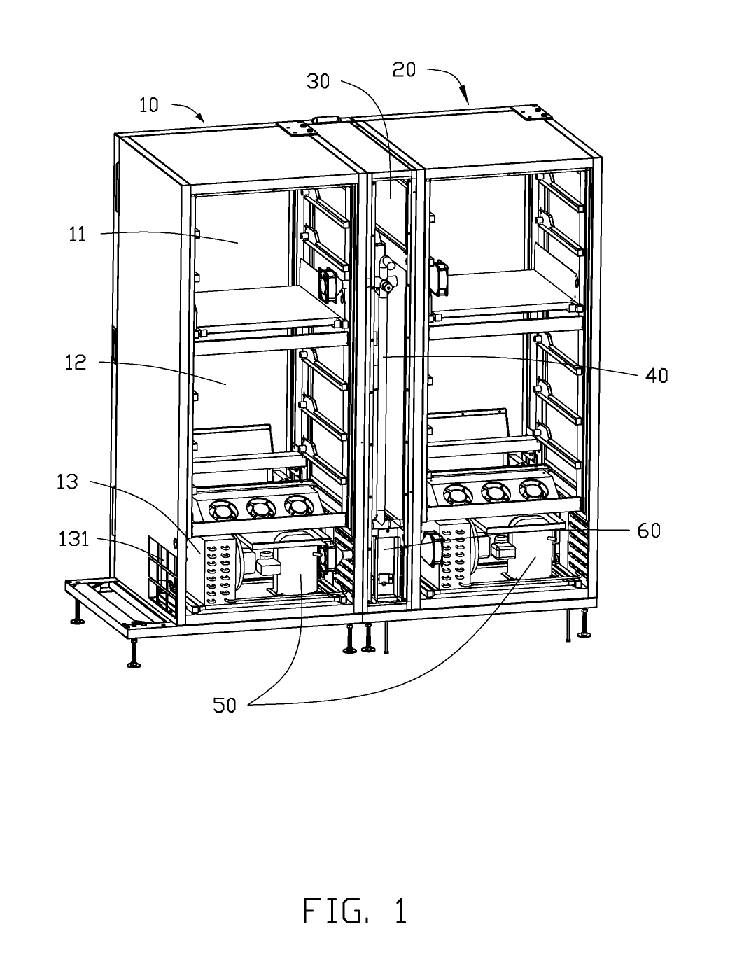

FIG. 1 illustrates an embodiment of an automatic vending machine. The automatic vending machine comprises a first rack 10, a second rack 20, a receiving area 30 defined between the first rack 10 and the second rack 20, a heat system 40 received in the receiving area 30, a refrigeration system 50, and a control system 60 received in the receiving area 30 for controlling the automatic vending machine.

The first rack 10 is substantially the same as the second rack 20, and each of the first rack 10 and the second rack 20 comprises a hot warehouse 11, a cold warehouse 12, and a refrigeration warehouse 13. The refrigeration warehouse 13 is for receiving the refrigeration system 50. A plurality of cabinets (not shown) can be located in the hot warehouse 11 and the cold warehouse 12 for storing a plurality of merchandise. The refrigeration system 50 is used for cooling the cold warehouse 12. A plurality of air outlets 131 is defined in the refrigeration warehouse 13.

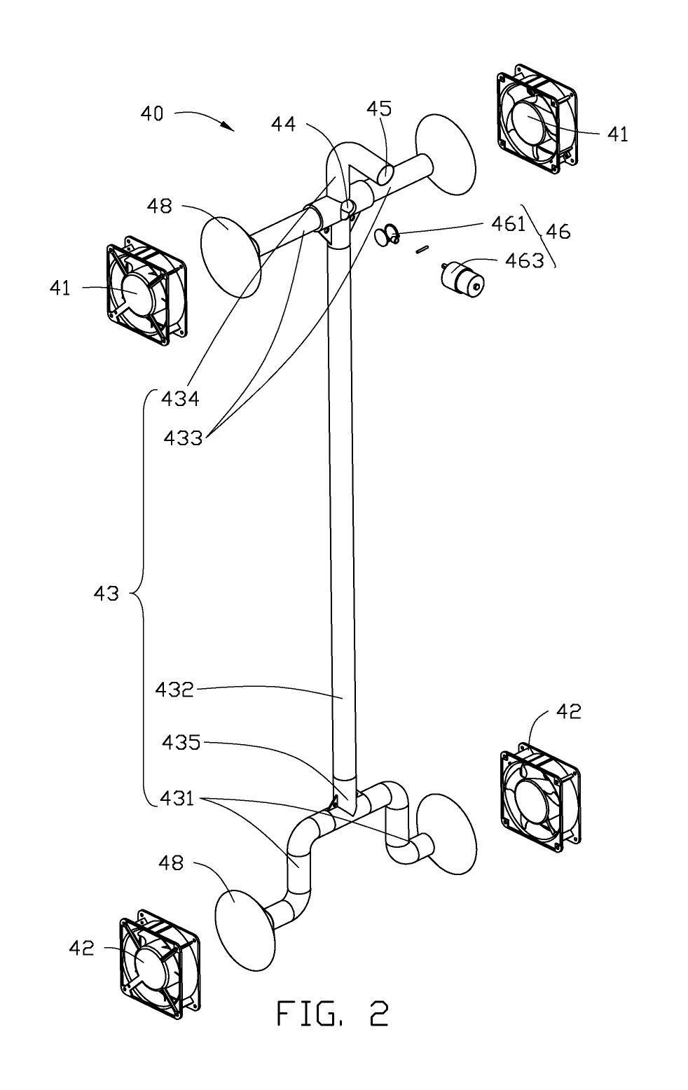

FIG. 2 illustrates an embodiment of the heat system 40. The heat system 40 is received in the receiving area 30 and used for heating the hot warehouse 11 (see FIG. 1). The heat system 40 comprises a ventilation device 43, a pair of first heat dissipating devices 41, a pair of second heat dissipating devices 42, a valve 46, and two pairs of mounting members 48. The ventilation device 43 comprises a pair of ending pipes 431, a first connecting pipe 432, a heat pipe 433, a second connecting pipe 434, and a third connecting pipe 435. In at least one embodiment, each ending pipe 431 is substantially L-shaped, the third connecting pipe 435 is substantially T-shaped, and the second connecting pipe 434 is substantially cross-shaped. A first end of the first connecting pipe 432 communicates with the pair of ending pipes 431 via the third connecting pipe 435. A second end of the first connecting pipe 432 communicates with the heat pipe 433 via the second connecting pipe 434. Therefore, the pair of ending pipes 431 communicate with the first connecting pipe 432, the heat pipe 433, the second connecting pipe 434, and the third connecting pipe 435. A mounting opening 44 is defined in the second connecting pipe 434. The valve 46 comprises a pair of shielding pieces 461 and a motor 463.

Each mounting member 48 is substantially funnel-shaped. A first pair of mounting members 48 is connected to the pair of first heat dissipating devices 41 and the pair of heat pipes 433, and a second pair of mounting members 48 is connected to the pair of second heat dissipating devices 42 and the pair of ending pipes 431. In one embodiment, each of the two pairs of first heat dissipating devices 41, 42 can be a fan.

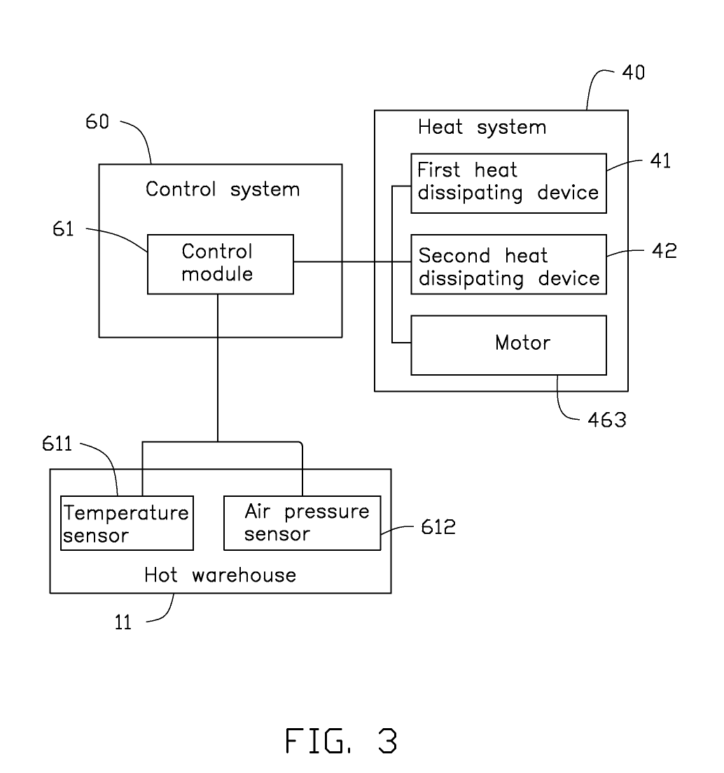

FIG. 3 illustrates an embodiment of the control system 60 and the heat system 40 of the automatic vending machine. A plurality of temperature sensors 611 and a plurality of air pressure sensors 612 are located in the hot warehouse 11. Each temperature sensor 61 is used to detect an actual temperature of the hot warehouse 11, and each air pressure sensor 612 is used to detect an actual air pressure of the hot warehouse 11. The control system 60 comprises a control module 61 for controlling the heat system 40.

FIGS. 1-5 illustrate assembly of the automatic vending machine. The pair of shielding pieces 461 is secured to the motor 463, and each shielding piece 461 is received in the mounting opening 44 to be located in a substantially central portion of the second connecting pipe 434. Thus, the motor 463 can cover the mounting opening 44 to prevent air from escaping out of the mounting opening 44. The ventilation device 43 is received in the receiving area 30, and each ending pipe 431 extends into the corresponding refrigeration warehouse 13. Each second heat dissipating device 42 is secured to the corresponding mounting member 48. Each heat pipe 433 extends into the corresponding hot warehouse 11. Each first heat dissipating device 41 is secured to the corresponding mounting member 48. Thus, the heat system 40 is secured in the receiving area 30. A ventilation hole 45 is defined in a top portion of the second connecting pipe 434 and exposed out of the receiving area 30.

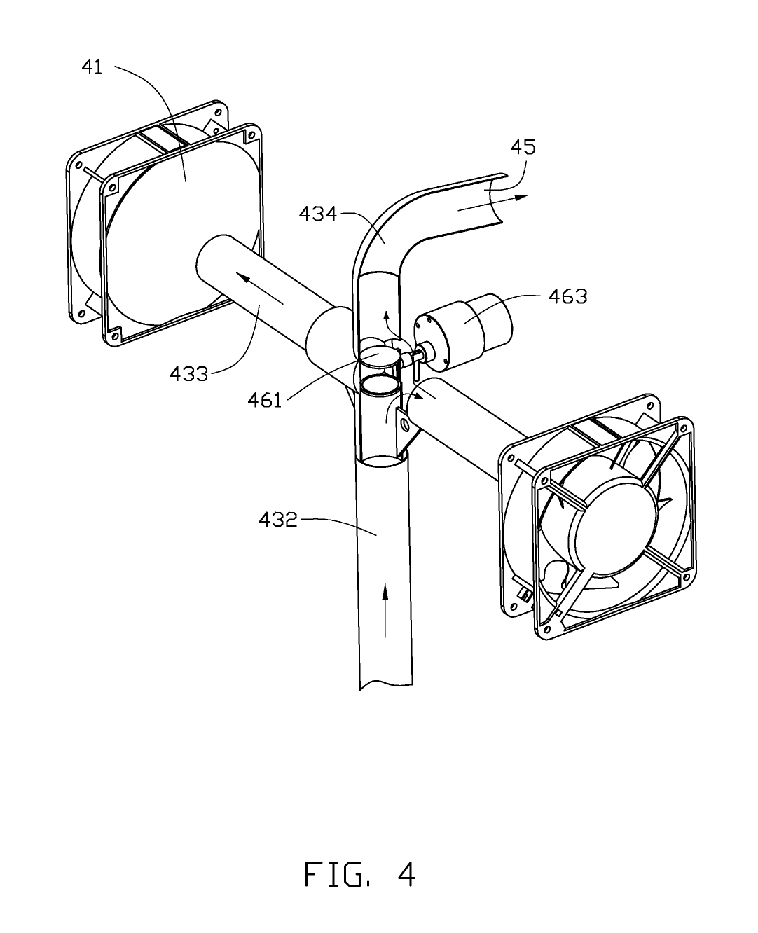

In use, when the temperature sensors 611 detect that the actual temperature in the hot warehouse 11 is less than a predetermined temperature, the temperature sensors 611 send a first signal to the control module 61. The control module 61 controls the heat system 40 to heat the hot warehouse 11. To heat the hot warehouse 11, the control module 61 controls the motor 463 to rotate the pair of shielding pieces 461 to a first position (see FIG. 4). When the pair of shielding pieces 461 is in the first position, the pair of shielding pieces 461 blocks air from flowing from the first connecting pipe 432 to the second connecting pipe 434, and air can flow from each heat pipe 433 to the second connecting pipe 434. The pair of second heating devices 42 is rotated to guide hot air generated by the refrigeration system 50 into the ending pipes 431. Thus, hot air generated by the refrigeration system 50 flows from the ending pipes 431 to the pair of heat pipes 433. The pair of first heat dissipating devices 41 is rotated in a first direction by the control module 61, so that the hot air in the heat pipes 433 can flow into the hot warehouse 11 to raise the temperature of the hot warehouse 11.

When the air pressure sensors 612 detect that the actual air pressure in the hot warehouse 11 is substantially equal to a first predetermined air pressure, the air pressure sensors 612 send a second signal to the control module 61. The pair of first heat dissipating devices 41 is rotated in a second direction opposite to the first direction by the control module 61, so that excess hot air in the hot warehouse 11 flows into the heat pipe 433 and out of the automatic vending machine via the ventilation hole 45. When the air pressure sensors 612 detect that the actual air pressure is substantially equal to a second predetermined air pressure less than the first predetermined air pressure, the air pressure sensors 612 send a third signal to the control module 61. The pair of first heat dissipating devices 41 is rotated in the first direction by the control module 61, so that the hot air in the first connecting pipe 432 can flow through each heat pipe 433 into the hot warehouse 11.

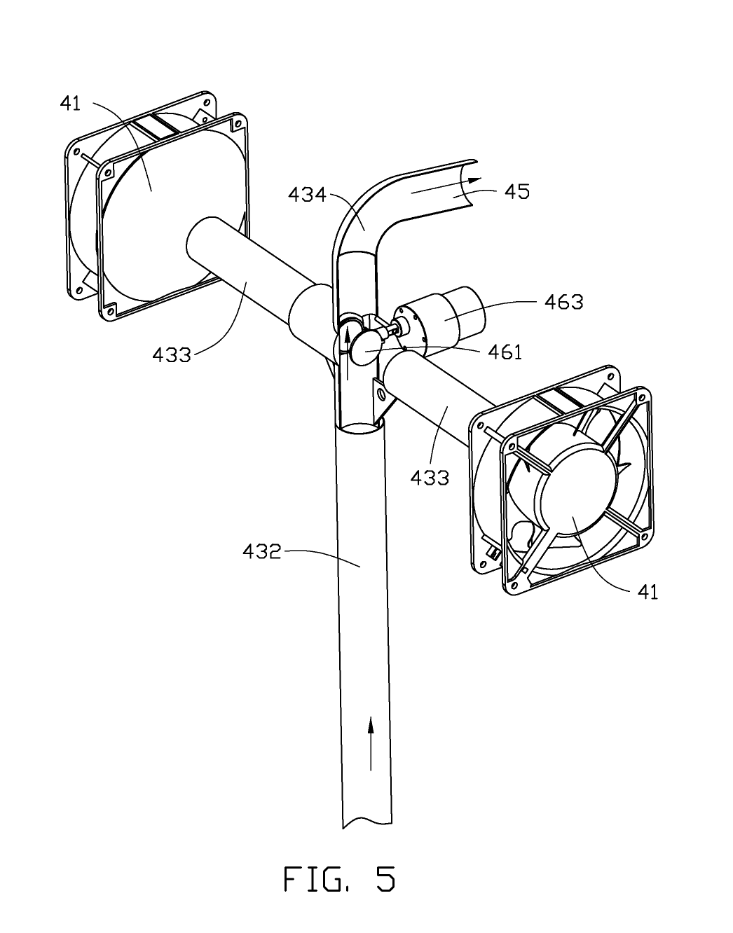

The above process is repeated until the temperature sensors 611 detect that the actual temperature of the hot warehouse 11 is substantially equal to the predetermined temperature. When the actual temperature is substantially equal to the predetermined temperature, the temperature sensors 611 send a fourth signal to the control module 61. The pair of first heat dissipating devices 41 and the pair of second heat dissipating devices 42 are controlled by the control module 61 to stop working, and the pair of shielding pieces 461 is rotated to a second position (see FIG. 5) by the motor 463. When the pair of shielding pieces 461 is in the second position, air is prevented from flowing from the second connecting pipe 434 into the heat pipes 433, and instead flows into the top portion of the second connecting pipe 434. Thus, air in the first connecting pipe 432 can flow out of the automatic vending mechanism via the ventilation hole 45.

When the heat system stops working, the hot air generated by the refrigeration system 50 can flow out of the automatic vending mechanism via the plurality of air outlets 131.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a hot warehouse;
a cold warehouse;
a refrigeration system configured for cooling the cold warehouse;
a heat system comprising a ventilation device, a first heat dissipating device, a second heat dissipating device, and a valve; and
a control system comprising a control module configured for controlling the heat system;
wherein the valve is rotated by the control module to communicate the ventilation device with the refrigeration system and the hot warehouse, and the first heat dissipating device and the second heat dissipating device are controlled by the control module, for allowing hot air generated by the refrigeration system to flow through the ventilation device into the hot warehouse.

2. The automatic vending machine of claim 1, wherein the heat system comprises a plurality of pipes, and the plurality of pipes communicates with each other.

3. The automatic vending machine of claim 2, wherein the plurality of pipes communicates with the refrigeration system and the hot warehouse, and the ventilation device further comprises a ventilation hole communicating with outside of the automatic vending machine.

4. The automatic vending machine of claim 3, wherein the valve comprises a shielding piece, the shielding piece is rotatable by the control module between a first position and a second position, when the shielding piece is located in the first position, one of the plurality of pipes located between the refrigeration system and the hot warehouse is opened to allow the hot air to flow into the warehouse; when the shielding piece is located in the second position, the one of the plurality of pipe is closed to allow the hot air to flow out of the automatic vending machine via the ventilation hole.

5. The automatic vending machine of claim 1, wherein a temperature sensor is located in the hot warehouse, the temperature sensor is configured to detect an actual temperature in the hot warehouse, and the first heat dissipating device and the second heat dissipating device are closed or opened by the control module according to the actual temperature.

6. The automatic vending machine of claim 1, wherein an air pressure sensor is located in the hot warehouse, the air pressure sensor is configured to detect an actual air pressure to send different signals to the control module; an air flowing direction of the first heat dissipating device and the second heat dissipating device is exchangeable by the control module according to the different signals.

7. The automatic vending machine of claim 1, wherein the ventilation device comprises an ending pipe, a first connecting piece, a second connecting pipe, a third connecting piece connected to the ending pipe, and a heat pipe connected to the second connecting pipe; and the first connecting pipe is connected to the second connecting pipe and the third connecting pipe.

8. The automatic vending machine of claim 7, wherein the first heat dissipating device, the ending pipe, the first connecting pipe, the second connecting pipe, the third connecting pipe, the heat pipe, and the second heat dissipating device together define a first flowing passage for air flowing through; the first heat dissipating device, the ending pipe, the first connecting pipe, the second connecting pipe, the third connecting pipe together define a second flowing passage for air flowing through; and the second heat dissipating device, the heat pipe, and the second connecting pipe together define a third flowing passage for air flowing through.

9. The automatic vending machine of claim 1, wherein the first heat dissipating device is a first fan, and the second heat dissipating device is a second fan.

10. An automatic vending machine comprising:
a hot warehouse;
a cold warehouse;
a refrigeration system configured for cooling the cold warehouse;
a heat system comprising a ventilation device, a first heat dissipating device, a second heat dissipating device, and a valve; the first heat dissipating device located in the hot warehouse, the second heat dissipating device located in the cold warehouse, and the ventilation device located between the first dissipating device and the second dissipating device; and
a control system comprising a control module configured for controlling the heat system;
wherein the valve is rotated by the control module to communicate the ventilation device with the refrigeration system and the hot warehouse, the first heat dissipating device and the second heat dissipating device are controlled by the control module, so that the ventilation device, the refrigeration system and the hot warehouse defines a first flowing passage for a hot air generated by the refrigeration system flowing through.

11. The automatic vending machine of claim 10, wherein and the ventilation device comprises a ventilation hole communicating with outside of the automatic vending machine.

12. The automatic vending machine of claim 11, wherein the valve comprises a shielding piece, the shielding piece is rotatable by the control module between a first position and a second position, when the shielding piece is located in the first position, one of the plurality of pipes located between the refrigeration system and the hot warehouse is opened to allow the hot air to flow into the warehouse; when the shielding piece is located in the second position, the one of the plurality of pipe is closed to allow the hot air to flow out of the automatic vending machine via the ventilation hole.

13. The automatic vending machine of claim 10, wherein a temperature sensor is located in the hot warehouse, the temperature sensor is configured to detect an actual temperature in the hot warehouse, and the first heat dissipating device and the second heat dissipating device are closed or opened by the control module according to the actual temperature.

14. The automatic vending machine of claim 10, wherein an air pressure sensor is located in the hot warehouse, the air pressure sensor is configured to detect an actual air pressure to send different signals to the control module; an air flowing direction of the first heat dissipating device and the second heat dissipating device is exchangeable by the control module according to the different signals.

15. The automatic vending machine of claim 10, wherein the ventilation device comprises an ending pipe, a first connecting piece, a second connecting pipe, a third connecting piece connected to the ending pipe, and a heat pipe connected to the second connecting pipe; and the first connecting pipe is connected to the second connecting pipe and the third connecting pipe.

16. The automatic vending machine of claim 15, wherein the first flowing passage is defined by the first heat dissipating device, the ending pipe, the first connecting pipe, the second connecting pipe, the third connecting pipe, the heat pipe, and the second heat dissipating device; the first heat dissipating device, the ending pipe, the first connecting pipe, the second connecting pipe, the third connecting pipe together define a second flowing passage for air flowing through; and the second heat dissipating device, the heat pipe, and the second connecting pipe together define a third flowing passage for air flowing through.

17. The automatic vending machine of claim 10, wherein the first heat dissipating device is a first fan, and the second heat dissipating device is a second fan.
